(19) United States
(12) Patent Application Publication
(10) Pub. No.: US 2012/0269976 A1
(43) Pub. Date: Oct. 25, 2012

(54) MOISTURE CURABLE ANTIFOULING COATING COMPOSITIONS

(76) Inventors: Yan HUANG, Shanghai (CN); Hongyu CHEN, Shanghai (CN); John ROPER, III, Midland, MI (US); Christopher TUCKER, Midland, MI (US); Gerald VANDEZANDE, Raleigh, NC (US); Yu ZHANG, Shanghai (CN)

(21) Appl. No.: 13/450,752

(22) Filed: Apr. 19, 2012

(30) Foreign Application Priority Data
Apr. 25, 2011 (CN) 201110115983.X

(51) Int. Cl. B05D 3/00; C09D 123/26

(52) U.S. Cl. 427/387; 524/572

(57) ABSTRACT

A one-package moisture curable composition is provided. The composition comprises, by weight percentage based on the dry weight of the composition, from 50 to 95% at least one silane terminated polybutadiene based polymer or silane terminated polyol based polymer and from 5 to 50% at least one fluoro/fluoroalkoxy-functionalized silane; wherein the composition, after moisture cured, forms a surface whose water contact angle is larger than 101°. The composition is suitable for the applications in antifouling coatings which affords low surface energy and improved mechanical performance.

### BACKGROUND

This invention relates to moisture curable compositions capable of forming polybutadiene-Si organic-inorganic hybrid networks having improved mechanical strength and excellent foul releasing property. The coating compositions are easily applied in the field of antifouling coatings.

Biofouling is the accumulation of living organisms such as bacteria, algae or barnacles on the submerged surface of marine vessels. Foul releasing coatings have been developed to achieve non-stick, foul releasing coating surfaces. Silica-gel based inorganic coatings which can form rigid cross-linked silica networks are observed having good hydrophobicity and improved mechanical strength. Low wettability and low critical surface tension endow the coating with improved antifouling or foul releasing properties, for example, reduced Ulva zoospore settlement, increased removal of zoospores, increased removal of Ulva biomass, and improved releasing performance of juvenile barnacles of Balanus amphitrite.

Polydimethylsiloxane (PDMS) based silicon rubber foul releasing coatings are widely used today due to their unique properties, for example, low surface energy, low elastic modulus, high thermal oxidative stability, UV resistance and non-toxicity. However, PDMS is extremely soft, and the mechanical weakness of coating limited its wider application. Since silicone component easily wears off, the silicone rubber based antifouling coating requires frequent reapplications, which is very fussy, costly and time consuming. An alternative coating with both excellent foul releasing property and mechanical strength is desirable.

Polyurethanes stand out by virtues of mechanical strength, elasticity, adhesion resistance and abrasion resistance in combination with PDMS in foul releasing coatings. U.S. Pat. No. 6,313,335 B1 describes a thermoset PU-PDMS dispersion for foul releasing coating. The proposed coating is prepared by reacting a mixture comprising: (A) polyol (B) polyisocyanate; (C) polyorganosiloxane having functional groups capable of reacting with the polyisocyanate. The resulting coating film shows improved mechanical and foul releasing properties. However, the polyurethane-PDMS coating is a two package thermoset system consisted of one package of polyol and hydroxyl or amino functionalized polyorganosiloxane and another package of polyisocyanate. Such two package system and the heat-curing process are not convenient in application, especially for those large surfaces which are difficult to be heat-treat. The PDMS raw material is relatively expensive.

Therefore, a novel one package coating composition which lowers the raw material cost and facilitates practical application, preferably with better durability and easy crosslinking process, such as moisture curing, is still desired.

The problem addressed by this invention is to find novel foul releasing compositions which can be self-crosslinked in moisture condition under room temperature to form an organic-inorganic hybrid network and suitable for the application in one package marine paints with improved mechanical durability and excellent foul releasing performance.

### STATEMENT OF INVENTION

The present invention is directed to a one-package moisture curable composition comprising, by weight percentage based on the dry weight of the composition, from 50 to 95% at least one silane terminated polybutadiene based polymer or silane terminated polyol based polymer and from 5 to 50% at least one fluoro/fluororalkoxy-functionalized silane having a formula R¹ₙSi(OR²)₄₋ₙ, where R¹ is a fluorinated linear, branched or cyclic and mono- or oligo-alkyl group with 1-18 carbon atoms, R₂ is an alkyl group and (OR²) is a hydrolytic group, and n is an integer form 1 to 2; wherein the silane terminated polybutadiene based polymer is the reaction product of (a) a polybutadiene based polymer having at least one non-hydrolysable organic X group in the main chain or on at least one of the two ends of the polybutadiene based polymer's backbone or on the side chains of the polybutadiene based polymer, the said X group is selected from hydroxyl, amino, isocyanate, epoxy, maleic anhydride, thiol and acrylic ester groups, and (b) an organosilane (RO)ₙSi[(CH₂)ₘY]₄₋ₙ, where the Y group is capable of reacting with the X group and selected from hydroxyl, amino, isocyanate, epoxy, maleic anhydride, thiol, acrylic ester and vinyl groups, where the R group is a hydrolysable group capable of participating in a condensation reaction, n is an integer form 1 to 3, and m is an integer from 0 to 60; and wherein the composition, after being moisture cured, forms a surface whose water contact angle is larger than 101°.

### DETAILED DESCRIPTION

The present invention achieves the moisture curable compositions by introducing silane groups into a polybutadiene system, different from the conventional polyorganosiloxane system, and then hydrolyzing and co-condensing to generate Si—O—Si bonds to form an organic-inorganic hybrid network, different from the organic-organic hybrid network described in the art. With such a network, the coating film achieves low surface energy and good mechanical properties.

The moisture curable composition comprises at least one silane terminated polybutadiene based polymer. The term “polybutadiene based polymer” herein is means a resin in which the polymer units are predominantly butadiene.

The silane-terminated polybutadiene based polymer may be the reaction product of a polybutadiene bearing one or more functional X groups with a compound of formula (RO)ₙS[(RCH₂)ₘY]₄₋ₙ; where n is an integer from 1 to 3, and m is an integer from 0 to 60, wherein X represents a reactive functional group such as, for example, hydroxyl, amino, isocyanate, epoxy, maleic anhydride, thiol and acrylic ester group, etc.; wherein Y represents a reactive functional group which is capable of reacting with the X group to form a silane-terminated polymer. Suitable Y group includes, for example, hydroxyl, amino, isocyanate, epoxy, maleic anhydride, thiol, acrylic ester and vinyl group. The reactive X groups can be on both ends of the polybutadiene backbone or on the side chains or in the main chain of the polybutadiene polymer.

In one embodiment, X is hydroxyl group(s) and Y is an isocyanate group. Therefore, the backbone of silane-terminated polybutadiene formed comprises one or more urethane linkages.

In another embodiment, X is isocyanate group(s) and Y is an amino group. Therefore, the backbone of silane-terminated polybutadiene formed comprises one or more urea linkages.

In yet another embodiment, X is epoxy group(s) and Y is an amino group. Therefore, the backbone of silane-terminated polybutadiene formed comprises one or more epoxy linkages.

Suitable isocyanate functionalized silanes include such as, for example, isocyanatopropyl triethoxysilane, isocyanatopropyl triemethoxysilane, isocyanatomethyl methyldiethoxysilane, isocyanatomethyl methyldimethoxysilane and the combinations thereof.

The content of the silane terminated polybutadiene based polymer in the moisture curable composition is, by weight percentage based on the dry weight of the composition, from 50 to 95%, preferably from 80 to 95%, more preferably from 80 to 90%.

The moisture curable composition comprises, by weight percentage based on the dry weight of the composition, from 5 to 50%, preferably from 5 to 20%, more preferably from 10 to 20%, at least one fluoro/fluororalkoxy-functionalized silane. The fluororalkoxy-functionalized silane may have a formula of, for example, R¹ₙSi(OR²)₄₋ₙ, wherein R¹ is a fluorinated linear, branched or cyclic and mono- or oligo-alkyl group with 1-18 carbon atoms, R² is an alkyl group and (OR²) is a hydrolytic group. Suitable polysiloxanes include, for example, polydimethylsiloxane, polydiethylsiloxane, and the combinations thereof.

The fluoro/fluororalkoxy-functionalized silane of the present invention is well known components of antifouling coating compositions in the art.

The moisture curable composition may further comprise, by weight percentage based on the dry weight of the composition, up to 50%, preferably up to 30%, more preferably up to 10%, at least one alkoxysilane additive other than the aforementioned fluororalkoxy-functionalized silane. The alkoxysilane introduced to the composition may function in the moisture curing procedure at room temperature, due to the hydrolytic groups of the alkoxysilane. The alkoxysilane used herein includes the below general formulae

R¹ₘSi(OR²)₄₋ₘ or Si(OR²)₄

wherein R¹ is independently a C₁-C₁₈ alkyl and/or C₆-C₂₀ aryl chain, R² is C₁-C₃ alkyl chain and (OR²) group is a hydrolytic group such as, for example, hexadecyltrimethoxysilane, octyltriethoxysilane, propyltriethoxysilane or tetraethoxysilane (TEOS).

Preferably, the silane terminated polybutadiene based polymer has a number average molecular weight in the range of from 500 to 200,000, more preferably from 1,000 to 50,000.

In one preferable embodiment of the present invention the moisture curable composition comprises, by weight based on the dry weight of the composition, from 50 to 95%, at least one silane terminated polybutadiene based polymer or silane terminated polyol based polymer and, from 5 to 50%, at least one fluoro/fluororalkoxy-functionalized silane.

The summation of the components' percentage in the moisture curable composition is 100%. When there is a selective component increase in the copolymer, other components may reduce their percentage by lowering their upper limit.

The term “up to” in a range means any and all amounts greater than zero and through to and including the end point of the range.

The moisture curable composition of the present invention is substantially free of water. “Substantially free of water” herein means the water contained in the composition is not sufficient to initiate a moisture curing process of the composition.

The present invention also provides antifouling coating compositions comprising the aforementioned moisture curable composition. The coating composition may further comprise hydrophobic agents conventionally used in the art to form a hydrophobic foul releasing surface. Suitable hydrophobic agents include, for example, Si-based hydrophobic agents such as siloxane, silane, silicone, polydimethylsiloxane (PDMS); fluoro-based hydrophobic agents such as fluorosilane, fluoroalkyl silane, polytetrafluoroethylene, polytrifluoroethylene, polyvinylfluoride, or functional fluoroalkyl compounds; and hydrocarbon hydrophobic agents such as reactive wax, polyethylene, or polypropylene. The inventors believe that other additives, when in appropriate concentrations, may be incorporated into the antifouling coating composition without substantially sacrifice other properties such as mechanical strength or durability. The coating composition may further comprise additives including dyes, pigments, antioxidants, UV stabilizers, biocides, thickeners or viscosity enhancers, in amounts generally used, according to application requirement.

In one preferred embodiment the antifouling coating composition is substantially free of biocidal compounds, such as, for example, copper oxide, 4,5-dichloro-2-n-octyl-4-isothiazolin-3-one (DCOI) sold under the trademark SEA-NINE™ 211, or the combinations thereof.

The antifouling coating composition, in addition to the silane terminated polybutadiene based polymer or silane terminated polyol based polymer and the fluoro/fluororalkoxy-functionalized silane of the moisture curable composition described herein, may also contain one or more additional polymeric binders such as, for example, other polyol, epoxy, or acrylic polymer.

The antifouling coating composition is prepared with techniques which are well known in the coatings art. At least one pigment is well dispersed in the coating composition under high shear such as is afforded by an IKA mixer or, in the alternative, at least one predispersed pigment may be used.

The solid content of the antifouling coating composition may be from about 50% to about 80% by volume. The viscosity of the composition may be from 0.05 to 10 Pa·s (50 cps to 10,000 cps), as measured using a Brookfield viscometer; the viscosities appropriate for different application methods vary considerably.

The moisture curable composition and the coating composition prepared therefrom are stable compositions in normal conditions and can be in the form of one package products for storage, transportation and application.

The moisture curable composition and the coating composition prepared therefrom can be self-cured by moisture at room temperature. In one example, hydroxyl terminated polybutadiene can be silynated solely, and then mixed with a fluoro/fluoroalkoxy silane or a silane terminated PDMS to obtain a crosslinked coating system. Theoretically, the fluoro/fluoroalkoxy-functionalized silane has a certain degree of compatibility with the silane terminated polybutadiene. The fluoro/fluoroalkoxy-functionalized silane or polysiloxane is prone to be covalently bonded with polybutadiene by hydrolysis and co-condensation of silane group. In a hypothesis but not to limit the invention, the inventors believe that in the present invention, due to the hydrolysis and co-condensation of silane groups of the silane terminated polybutadiene based polymer and the fluoro/fluoroalkoxy-functionalized silane, Si—O—Si bonds are generated and thus results a crosslinked organic-inorganic hybrid network. The Si—O—Si inorganic bonds strengthen the hybrid network and offer improved mechanical performance. Moreover, the inventors believe that, with appropriate molecular weight, the polysiloxane component or fluoro/fluoroalkoxy chain migrates to the surface of the coating film, due to the surface energy driving force. Such migration offers the coating film surface with low surface energy. Meanwhile, silane terminated polybutadiene provides good adhesion to the substrate or primer coating and also contribute to the outstanding mechanical properties.

The antifouling coating composition may be applied by conventional application methods such as, for example, brushing, roller application, and spraying methods such as, for example, air-atomized spray, air-assisted spray, airless spray, high volume low pressure spray, and air-assisted airless spray.

The antifouling coating composition may be applied to a substrate such as, for example, metal, plastic, wood, stone, concrete, primed surfaces, previously painted surfaces, and cementitious substrates. The coating composition coated on the substrate is typically dried, or allowed to dry, at a temperature of from −10° C. to 95° C.

The surface energy of the coating film surface is tested to indicate the foul-releasing property of the antifouling coating composition. The adhesion strength of marine organisms such as barnacles to the coating surface generally relates to the surface energy of the coatings. Usually marine microorganisms have low adhesion strength to a surface with low surface energy. A generic parameter which reflects the surface energy of the coating is the contact angle. A water droplet on the surface with low surface energy will show a very high static contact angle. If the contact angle is larger than 90°, the surface is hydrophobic. For the foul releasing coating application, it is desirable if the water static contact angle is larger than 101°. A fluoro/fluoroalkoxy-functionalized silane shows good hydrophobicity in nature and tends to predominate on the surface of coatings because of the surface energy driving force. There are hardly any materials which will adhere well to the surfaces of this type, and materials deposited on surfaces of this type are in turn very easy to remove.

The coating film formed from the coating composition of the present invention is believed, in morphology, to comprise predominantly a bottom layer of tough polybutadiene, Si—O—Si crosslinked networks, and a top layer rich in fluorine with low surface energy, all of which are favorable for durable foul releasing applications.

The advantages of the polybutadiene-Si hybrid system include the capatability of being produced, stored and transported in one-package form, moisture curability at room temperature, low toxicity (no free isocyanate), environmental benignness, excellent film forming properties, improved mechanical performance, and excellent foul releasing property.

In the present specification, the technical features in each preferred technical solution and more preferred technical solution can be combined with each other to form new technical solutions unless indicated otherwise. For briefness, the Applicant omits descriptions of these combinations. However, all the technical solutions obtained by combining these technical features should be deemed as being literally described in the present specification in an explicit manner.

### EXAMPLES

### I. Raw Materials

Material used in the antifouling coating materials

| Material | Function | Chemical nature | Supplier |
|---|---|---|---|
| LBH-2000 | PB | Hydroxyl terminated | Sartomer |
| | | polybutadiene | Company Inc |
| LBH-2000 | PB | Hydroxyl terminated | Sartomer |
| | | polybutadiene | Company Inc |
| DWD 2080 | NOP | Gen 1 NOP | Dow Chemical |
| | polyol | | |
| IPTES | Silane | Isocyanatopropyl | TCI |
| | | triethoxysilane | |
| APTES | Silane | 3-aminopropyl- | Adrich |
| | | triethoxysilane | |
| DBTL | Catalyst | Dibutyltin dilaurate | Sinopharm |
| | | | Chemical |
| | | | Reagent |
| | | | Company |
| p- | Catalyst | p-toluenesulfonic acid | Sinopharm |
| toluenesulfonic | | | Chemical |
| acid | | | Reagent |
| | | | Company |
| HDI | Di- | 1,6-hexamethylene | TCI |
| | isocyanate | diisocyanate | |
| | | propanol | |
| IPDI | di- | Isophorone | TCI |
| | isocyanate | diisocyanate | |
| Butyl acetate | Solvent | Butyl acetate | Eastman |
| F-silane | F-silane | Tridecafluorooctyl- | Degussa |
| | | triethoxysilane | |
| TEOS | Silane | Tetraethoxysilane | Sinopharm |
| | | | Chemical |
| | | | Reagent |
| | | | Company |
| C8-TEOS | Silane | Octyltriethoxysilane | Adrich |
| EtOH | Solvent | Ethanol | Sinopharm |
| | | | Chemical |
| | | | Reagent |
| | | | Company |

### II. Test Procedures

Pseudo-Barnacle Pull Off Strength Test The test was carried out according to a modified procedure as described in reference (Kohl J G & Singer I L, Pull-off behavior of epoxy bonded to silicone duplex coatings, Progress in Organic Coatings, 1999, 36:15-20) using an Elcometer™ pull off strength tester.

Ten-millimeter diameter aluminum studs were designed for the Elcometer™ instrument. The epoxy adhesive (Araldite™ resin) was used to glue the studs to the surface of the coated panels. The excessive epoxy was trimmed after about one hour cure. The epoxy adhesive was then allowed to harden for three days at room temperature. The stud was then pulled off by the Elcometer™ instrument till the stud detached from the coating surface. For each test, at least three replicate samples were employed and the average value for pull off strength (MPa) was recorded. If the pseudo-barnacle pull off strength is equal to or lower than 0.5 MPa, it indicates that the coating has good foul releasing property.

### Impact Resistance Test

Impact tests were applied according to ASTM D 2794-93 to evaluate the mechanical strength of the PB—Si hybrid coatings. The coating was applied on a steel panel and cured under moisture at room temperature. After the fully cure of the coating, the coated steel panel was placed under a 2-lb load which has a round tip with a diameter of 0.5 inch. The load was lifted to a certain height and then dropped to generate an impact on the coating and the steel panel. When the height of the lifted load was higher than a certain value, the coating would be damaged by the impact generated by the dropping load. The value was recorded to evaluate the impact resistance performance of the coating.

### Example 1

Preparation of silane terminated polybutadiene: 10.5 g of α,ω-hydroxyl terminated polybutadienene Krasol™ LBH-2000 was introduced into a 250 mL round bottom flask equipped with a mechanical stirrer. 2.73 g of IPTES and 5.67 g butyl acetate were added into the round bottom flask. The mixture was stirred at 75° C. under nitrogen protection. 0.1 wt % of catalyst DBTL was added. The reaction was allowed to proceed until complete disappearance of isocyanate functional groups, which was confirmed by IR analysis. The resulting samples of modified polybutadiene were transparent and stable at room temperature.

Synthesis of PB—Si gel hybrid coating: 5 g of silane functionalized polybutadiene solution (70% solid) was mixed with 0.35 g of tridecafluorooctyltriethoxysilane in a glass jar with a straight magnetic stirring bar. 0.2 wt % p-toluenesulfonic acid was added into the solution as a catalyst for hydrolysis and condensation process of silane groups. The solution was vigorously stirred for 20 min. The above formulation was coated using blade coater on an aluminum panel (H.J. Unkel LTD. Company). A wet coating with the thickness of 300 μm was applied to clean aluminum panels (H.J. Unkel LTD. Company). The coated panels were allowed to dry at room temperature for at least 2 days prior to contact angle measurements and pseudo-barnacle pull off strength test. Contact angles were measured using an OCA 20 contact angle instrument (DataPhysics Company). A coating surface with good foul releasing property exhibits static contact angles of >101°.

The pseudo-barnacle pull off test showed that the coating had very good foul releasing performance, with pseudo-barnacle pull off strength from 0.2 to 0.5 MPa.

The formulations of the moisture curable sol-gel based coatings were listed in Table 1. In all formulations, IPTES was used as functionalized silane to terminate the PB/polyols.

TABLE 1
Moisture curable PB/polyol-Si coating compositions

| | | | | | | Pseudo- |
|---|---|---|---|---|---|---|
| | | | | | | barnacle |
| | | Silylated | F-Silane | TEOS | Contact | pull off |
| Coating | | PB/polyol | (solid | (solid | angle | strength |
| Sample | PB/polyol | (solid wt %) | wt %) | wt %) | (°) | (MPa) |
| 1 | LBH-2000 | 95 | 5 | 0 | 105 | 0.5 |
| 2 | LBH-2000 | 90 | 10 | 0 | 110 | 0.2 |
| 3 | LBH-2000 | 80 | 10 | 10 | 109 | 0.3 |
| 4 | LBH-2000 | 70 | 10 | 20 | 108 | 0.4 |
| 5 | LBH-2000 | 80 | 20 | 0 | 120 | 0.2-0.3 |
| 6 | LBH-2000 | 50 | 50 | 0 | 122 | 0.2-0.3 |
| 7 | LBH-3000 | 90 | 10 | 0 | 112 | 0.2 |
| ^{a}Comp. | LBH-2000 | 100 | 0 | 0 | 85 | >3 |
| Sample | | | | | | |
| 1 | | | | | | |

| | | | |
|---|---|---|---|
| ^{b}Comp. | Sol-gel coating according to the reference: | 106 | 0.6 |
| Sample | Ying Tang et al., Biofouling, 2005, 21: 59-71 | | |
| 2 | | | |
| ^{c}Comp. | Sol-gel coating modified by | 118 | 0.4 |
| Sample | tridecafluorooctyltriethoxysilane | | |
| 3 | | | |
| ^{d}Comp. | 2 Package PU-PDMS coating described in | 107 | 0.2 |
| Sample | U.S. Pat. No. 6,313,335 B1 | | |
| 4 | | | |

^{a}Comparative sample 1 was a pure silylated PB coating prepared by the method described in Example 1.
^{b}Comparative sample 2 was a sol-gel based foul releasing coating according to the literature (Ying Tang et al., Biofouling, 2005, 21, 59-71). 2.76 g C8-TEOS, 2.08 g TEOS and 5 mL EtOH were mixed and 1.6 ml of 0.1N HCL was added and stirred for 2 hours at room temperature. The coating was prepared as described in Example 1. The sol-gel coating showed poor foul releasing property.
^{c}Comparative sample 3 was the sol-gel coating which was further modified by tridecafluorooctyltriethoxysilane to provide extra low surface energy. 0.2 g tridecafluorooctyltriethoxysilane, 2.08 g TEOS and 5 mL EtOH were mixed and 1.6 ml of 0.1N HCL was added and stirred for 2 hours at room temperature. The coating was prepared as described in Example 1.
^{d}Comparative sample 4 was a two-package PU-PDMS coating prepared according to U.S. Pat. No. 6,313,335 B1, with the following process: 1.7 g nature seed oil polyol with equivalent weight of 170 g/mol and functionality of 3, PDMS, solvents, and catalyst were measured into a one ounce glass jar with a magnetic stir bar. The solution was mixed at room temperature for 10 minutes. Then HDI trimer was added to the mixture. The mixture was stirred for 20 minutes and then coated on an aluminum panel as describe above in Example 1.

Comparative Sample 1 showed low water contact angle and poor foul releasing property based on pseudo-barnacle pull off strength test. Although Comparative Sample 2 showed good water contact angle, the pseudo-barnacle pull off strength was higher than PB—Si—F hybrid coating. Further modification by tridecafluorooctyltriethoxysilane can make sol-gel coating more hydrophobic and reach an acceptable pseudo-barnacle pull off strength, as shown in Comparative Sample 3. It was observed that the coating film made from the pure inorganic Si—O—Si was very brittle and easily cracked, especially when the coating was as thick as 300 μm in wet film. The impact resistance property for sol-gel coatings was very poor. However, the PB based hybrid coatings were elastic and showed much better impact resistance, as shown in Table 2. The one-package coating compositions, Samples 1-7, achieved as good mechanical and foul releasing properties as the two-package PU-PDMS coating (Comparative Sample 4).

TABLE 2
Result of impact resistance of coatings

| | Impact resistance |
|---|---|
| Coating sample | (cm) |
| 2 | 50 |
| 7 | 50 |
| Comp. Sample 2 | <10 |
| Comp. Sample 3 | <10 |
| Comp. Sample 4 | 25 |

### Example 2

Preparation of silane terminated polybutadiene based polyurethane polymer. To increase the molecular weight of polybutadiene base polymer, a reaction was carried out between a hydroxyl terminated polybutadiene and an excess of diisocyanate with molar ratio of NCO/OH=2. The isocyanate terminated polyurethane prepolymer was designed to react with amino functionalized silane to obtain a silane terminated polybutadiene based polymer. 10.5 g of α,ω-hydroxyl terminated polybutadiene Krasol™ LBH-2000 was introduced into a 250 mL round bottom flask equipped with a mechanical stirrer. 1.68 g of 1,6-hexamethylene diisocyanate and 5.20 g of butyl acetate were added into the round bottom flask. 0.1 wt % of DBTL was added. The mixture was stirred at 75° C. under nitrogen protection for 1 hour. 2.26 g of APTES was carefully added in the flask without exposure to air. The reaction was allowed to proceed until complete disappearance of isocyanate functional groups, which was confirmed by IR analysis. The resulting samples were transparent and stable at room temperature.

Synthesis of hybrid coating: 5 g of silane terminated polybutadiene polyurethane solution (70% solid) was mixed with 0.35 g of tridecafluorooctyltriethoxysilane in a glass jar with a straight magnetic stirring bar. 0.2 wt % p-toluenesulfonic acid was added in the solution as a catalyst for hydrolysis and condensation process of silane group. The solution was vigorously stirred for 20 minutes. The coating was prepared as in Example 1. The coating surface exhibited static contact angles of 113° and the pseudo-barnacle pull off strength was 0.2 MPa.

The formulations of the moisture curable sol-gel based coatings were listed in Table 3. In all formulations, HDI was employed as diisocyanate (with initial mole ratio of NCO/OH=2) and APTES was used as functionalized silane to terminate the prepolymers.

TABLE 3
Moisture curable PB/polyol-Si coating compositions

| | | Silylated | | | Pseudo- |
|---|---|---|---|---|---|
| | | PB/polyol | | Contact | barnacle pull |
| Coating | | (solid | F-Silane | angle | off strength |
| Sample | PB/polyol | wt %) | (solid wt %) | (°) | (MPa) |
| 8 | LBH-2000 | 90 | 10 | 113 | 0.2 |
| 9 | LBH-3000 | 90 | 10 | 115 | 0.2 |

### Example 3

The same as Example 2 except the mole ratio of NOP and diisocyanate was changed to NCO/OH=0.5. The silylation process was carried out by reacting isocyanatopropyl triethoxysilane with hydroxyl terminated PB prepolymer. The coating was prepared as in Example 2.

The formulations on the moisture curable sol-gel based coatings were listed in Table 4. In all formulations, HDI was employed as diisocyanate (with initial mole ratio of NCO/OH=0.5) and IPTES was used as functionalized silane to terminate the prepolymers.

TABLE 4
Moisture curable PB/polyol-Si coating compositions

| | | | | | Pseudo- |
|---|---|---|---|---|---|
| | | Silylated | F-Silane | Contact | barnacle pull |
| Coating | | PB/polyol | (solid | angle | off strength |
| Sample | PB/polyol | (solid wt %) | wt %) | (°) | (MPa) |
| 10 | LBH-2000 | 90 | 10 | 114 | 0.3 |
| 11 | LBH-3000 | 90 | 10 | 115 | 0.3 |

1. A one-package moisture curable composition comprising, by weight percentage based on the dry weight of the composition, from 50 to 95% at least one silane terminated polybutadiene based polymer and from 5 to 50% at least one fluoro/fluoroalkoxy-functionalized silane having a formula R¹ₙSi(OR²)₄₋ₙ, where R¹ is a fluorinated linear, branched or cyclic and mono- or oligo-alkyl group with 1-18 carbon atoms, R₂ is an alkyl group and (OR²) is a hydrolytic group, n is an integer form 1 to 2;
wherein the silane terminated polybutadiene based polymer is the reaction product of (a) a polybutadiene based polymer having at least one non-hydrolysable organic X group in the main chain or on at least one of the two ends of the polybutadiene based polymer's backbone or on the side chains of the polybutadiene based polymer, and selected from hydroxyl, amino, isocyanate, epoxy, maleic anhydride, thiol and acrylic ester groups, and (b) an organosilane (RO)ₙSi[(CH₂)ₘY]₄₋ₙ, where the Y group is capable of reacting with the X group and selected from hydroxyl, amino, isocyanate, epoxy, maleic anhydride, thiol, acrylic ester and vinyl groups, where the R group is a hydrolysable group capable of participating in a condensation reaction, n is an integer form 1 to 3, and m is an integer from 0 to 60; and wherein the composition, after being moisture cured, forms a surface whose water contact angle is larger than 101°.

2. The composition according to claim 1, wherein the polybutadiene is the product of 1,2 polymerization or 1,4 polymerization of 1,3-butadiene, or the combinations thereof.

3. The composition according to claim 1, wherein the X group is a hydroxyl group and the Y group is an isocyanate group, or the X group is an isocyanate group and the Y group is an amino group, or the X group is an epoxy group and the Y group is an amino group

4. The composition according to claim 1, wherein the fluoro/fluoroalkoxy-functionalized silane has a formula R¹ₙSi(OR²)₄₋ₙ, where R¹ is a fluorinated linear, branched or cyclic and mono- or oligo-alkyl group with 1-18 carbon atoms, R₂ is an alkyl group and (OR²) is a hydrolytic group.

5. The composition according to claim 1, wherein the amount of the silane terminated polybutadiene based polymer ranges from 50 to 90 wt %.

6. The composition according to claim 1, wherein the amount of the fluoro/fluororalkoxy-functionalized silane ranges from 10 to 50 wt %.

7. The composition according to claim 1, wherein the silane terminated polybutadiene based polymer has a number average molecular weight in the range of from 500 to 200,000.

8. A coating composition comprising the moisture curable composition of claim 1.

9. A method of coating a substrate comprising the steps of;
(a) providing the composition of claim 1; and
(b) applying the composition to substrate and exposing to moisture to initiate cure of the composition.

10. A coating film derived from the moisture curable composition of claim 1.
